(19) United States
(12) Patent Application Publication
(10) Pub. No.: US 2025/0116802 A1
(43) Pub. Date: Apr. 10, 2025

(54) OPTICAL FILTER AND IMAGING APPARATUS

(71) Applicant: AGC Inc., Tokyo (JP)

(72) Inventors: Kazuhiko SHIONO, Fukushima (JP); Takuro SHIMADA, Fukushima (JP); Yuichiro ORITA, Fukushima (JP); Takahiro SAKAGAMI, Shizuoka (JP); Takashi NAGATA, Shizuoka (JP); Katsushi KAMIJYO, Shizuoka (JP)

(73) Assignee: AGC Inc., Tokyo (JP)

(21) Appl. No.: 18/988,429

(22) Filed: Dec. 19, 2024

Related U.S. Application Data
(63) Continuation of application No. PCT/JP2023/022121, filed on Jun. 14, 2023.

(30) Foreign Application Priority Data
Jun. 24, 2022 (JP) 2022-102257

(51) Int. Cl. G02B 5/22; G02B 1/11

(52) U.S. Cl. CPC G02B 5/22; G02B 1/11

(57) ABSTRACT

An optical filter includes a glass substrate having a first main surface and a second main surface opposite each other and including phosphoric acid glass, a first antireflective layer disposed directly or indirectly on the first main surface of the glass substrate, and a resin layer, containing dye, disposed as one or more layers directly or indirectly on the second main surface of the glass substrate, wherein the glass substrate includes a predetermined range of amount of oxides, wherein the dye has a maximum absorption wavelength in the resin layer at a wavelength range of 690 to 800 nm, wherein thickness of the resin layer is 10 μm or less, wherein the optical filter has all spectral characteristics specified in (a-1) to (a-6), and wherein a Haze value of the optical filter is 2% or less.

### CROSS-REFERENCE TO RELATED APPLICATIONS

This application is a continuation application of International Application No. PCT/JP2023/022121, filed on Jun. 14, 2023, and designated the U.S., which is based upon and claims priority to Japanese Patent Application No. 2022-102257, filed on Jun. 24, 2022. The entire contents of these applications are incorporated herein by reference.

### BACKGROUND OF THE INVENTION

### 1. Field of the Invention

The disclosures herein relate to optical filters and imaging apparatuses.

### 2. Description of the Related Art

Imaging apparatuses such as vehicle-mounted cameras and smartphone cameras are provided with solid-state imaging devices (CCD, CMOS, etc.). However, the solid-state imaging device shows higher sensitivity to infrared light than human visual sense. Therefore, in order to bring an image captured by the solid-state imaging device closer to human visual perception, an optical filter is further installed in the imaging apparatus.

A high-precision optical filter is required to have (1) high transmittance in a visible light region, (2) high light shielding performance in an infrared light region, and (3) an optical property that does not change with the incidence angle of light.

In order to satisfy these properties, Patent Literature (PTL) 1 describes an optical filter having a CuO-containing fluorophosphate glass substrate. The CuO-containing fluorophosphate glass substrate has a function of absorbing infrared rays to some extent. Therefore, by combining a CuO-containing fluorophosphate glass substrate, a dye-containing layer, and a dielectric multilayer film, the optical filter having effects (1) to (3) described above can be provided.

However, the inventors of the present application have recognized that the effects (2) and (3) described above are not sufficient even in the optical filter described in PTL 1. In particular, the optical filter for a camera mounted on an electronic device such as a smartphone has increasingly become required to be more power saving in recent years. As such a power saving optical filter progresses, a problem of angular dependence of optical properties is expected to become more prominent in the future.

An object of the present invention is to provide the optical filter having significantly high light shielding performance in the infrared region and significantly reduced angular dependence of optical properties.

### CITATION LIST

### Patent Literature

[PTL 1] International Publication 2014/030628

### SUMMARY OF THE INVENTION

According to one embodiment of the present invention, an optical filter includes a glass substrate having a first main surface and a second main surface opposite each other and including phosphoric acid glass, a first antireflective layer disposed directly or indirectly on the first main surface of the glass substrate, and a resin layer, containing dye, disposed as one or more layers directly or indirectly on the second main surface of the glass substrate, wherein the glass substrate includes, in a percentage by mass on an oxide basis:
50 to 80% of P₂O₅;
5 to 20% of Al₂O₃;
4 to 20% of CuO;
0.5 to 15% of R(1)₂O, wherein R(1) is at least one component selected from a group consisting of Li, Na, K, Rb, and Cs; and
0 to 15% of R(2)O, wherein R(2) is at least one component selected from the group consisting of Ca, Mg, Ba, Sr, and Zn,
wherein the dye has a maximum absorption wavelength in the resin layer at a wavelength range of 690 to 800 nm,
wherein a thickness of the resin layer is 10 μm or less, wherein the optical filter has spectral characteristics specified as:
(a-1) a transmittance T₍ₜ₎₄₅₀ at a wavelength of 450 nm is 80% or more at incidence angles of 0° and 50°;
(a-2) an average transmittance T₍ₜ₎ₐᵥₑ₁ in a wavelength range of 450 to 600 nm is 78% or more at incidence angles of 0° and 50°;
(a-3) a maximum transmittance T₍ₜ₎ₘₐₓ₁ in the wavelength range of 450 to 600 nm is 85% or more at incidence angles of 0° and 50°;
(a-4) a minimum wavelength λ₍ₜ₎₅₀ at which the transmittance is 50% is in a range of 600 to 650 nm at incidence angles of 0° and 50°;
(a-5) an average transmittance T₍ₜ₎ₐᵥₑ₂ in a wavelength range of 750 to 1200 nm is 4.0% or less at incidence angles of 0° and 50°; and
(a-6) a maximum transmittance T₍ₜ₎ₘₐₓ₂ in a wavelength range of 1000 to 1200 nm is 15% or less at incidence angles of 0° and 50°, and wherein a Haze value of the optical filter is 2% or less.

According to one embodiment of the present invention, the optical filter can be provided which has the significantly high light shielding performance in the infrared region and the angular dependence of optical properties is significantly reduced.

### BRIEF DESCRIPTION OF THE DRAWINGS

FIG. 1 is a drawing illustrating a comparison of typical optical properties between a fluorophosphate glass (a) and a phosphate glass (b) containing CuO;

FIG. 2 is a cross-sectional view schematically illustrating a configuration example of an optical filter according to one embodiment of the present invention;

FIG. 3 is a cross-sectional view schematically illustrating a configuration example of an optical filter according to another embodiment of the present invention;

FIG. 4 is a drawing schematically illustrating an example of optical properties of a glass substrate included in the optical filter according to one embodiment of the present invention;

FIG. 5 is a drawing schematically illustrating an example of optical properties of a resin layer included in the optical filter according to one embodiment of the present invention;

FIG. 6 is a drawing schematically illustrating an example of optical properties of the optical filter according to one embodiment of the present invention;

FIG. 7 is a drawing schematically illustrating an example of a transmittance profile obtained in the optical filter according to one embodiment of the present invention;

FIG. 8 is a drawing schematically illustrating an example of a reflectance profile obtained in the optical filter according to one embodiment of the present invention; and

FIG. 9 is a drawing schematically illustrating an example of a transmittance profile obtained in an optical filter according to another embodiment of the present invention.

### DESCRIPTION OF THE PREFERRED EMBODIMENTS

In the following, one embodiment of the present invention will be described with reference to the accompanying drawings.

As described above, the effects (2) and (3) described above are still insufficient in conventional optical filters. Therefore, there is a possibility that related optical filters cannot sufficiently prevent light leakage in the infrared region and/or a phenomenon that the optical properties change depending on the incidence angle of light (hereinafter, referred to as an “angular dependence problem”). In particular, it is expected that the “angular dependence problem” will become more pronounced in the future as optical filters become further power saving.

Against this background, the inventors of the present application have earnestly studied and developed a structure of an optical filter capable of further enhancing the effects (2) and (3). The inventors of the present application have found that absorption in the infrared region can be further enhanced when phosphate glass is used instead of fluorophosphate glass as the glass substrate containing an absorbent, and that the “angular dependence problem” can be solved by discontinuing use of an infrared cut film.

However, when the dye-containing layer is thickened in order to enhance the effect (2), the Haze value of the optical filter increases and the reflectance of light increases, so that vividness of the image tends to decrease. The inventors of the present application have also studied such a problem of the Haze value. As a result, it was found that by setting the Haze value of the optical filter to a specific range, the light shielding performance in the infrared region can be significantly enhanced while maintaining the vividness of the image.

Therefore, one embodiment of the present invention provides the optical filter includes a glass substrate having a first main surface and a second main surface opposite each other and including phosphoric acid glass, a first antireflective layer disposed directly or indirectly on the first main surface of the glass substrate, and a resin layer, containing dye, disposed as one or more layers directly or indirectly on the second main surface of the glass substrate, wherein the glass substrate includes, in a percentage by mass on an oxide basis:
50 to 80% of P₂O₅;
5 to 20% of Al₂O₃;
4 to 20% of CuO;
0.5 to 15% of R(1)₂O, wherein R(1) is at least one component selected from a group consisting of Li, Na, K, Rb, and Cs; and
0 to 15% of R(2)O, wherein R(2) is at least one component selected from the group consisting of Ca, Mg, Ba, Sr, and Zn,
wherein the dye has a maximum absorption wavelength in the resin layer at a wavelength range of 690 to 800 nm,
wherein a thickness of the resin layer is 10 μm or less, wherein the optical filter has spectral characteristics specified as:
(a-1) a transmittance T₍ₜ₎₄₅₀ at a wavelength of 450 nm is 80% or more at incidence angles of 0° and 50°;
(a-2) an average transmittance T₍ₜ₎ₐᵥₑ₁ in a wavelength range of 450 to 600 nm is 78% or more at incidence angles of 0° and 50°;
(a-3) a maximum transmittance T₍ₜ₎ₘₐₓ₁ in the wavelength range of 450 to 600 nm is 85% or more at incidence angles of 0° and 50°;
(a-4) a minimum wavelength λ₍ₜ₎₅₀ at which the transmittance is 50% is in a range of 600 to 650 nm at incidence angles of 0° and 50°;
(a-5) an average transmittance T₍ₜ₎ₐᵥₑ₂ in a wavelength range of 750 to 1200 nm is 4.0% or less at incidence angles of 0° and 50°; and
(a-6) a maximum transmittance T₍ₜ₎ₘₐₓ₂ in a wavelength range of 1000 to 1200 nm is 15% or less at incidence angles of 0° and 50°, and wherein a Haze value of the optical filter is 2% or less.

In the present description, the Haze value refers to a value measured in accordance with JIS K7136.

In an optical filter according to one embodiment of the present invention, an infrared cut film is not used. Therefore, an optical filter according to one embodiment of the present invention is unlikely to cause an “angular dependence problem”, and for example, when the incidence angle of light changes from 0° to 50°, the optical properties do not much change.

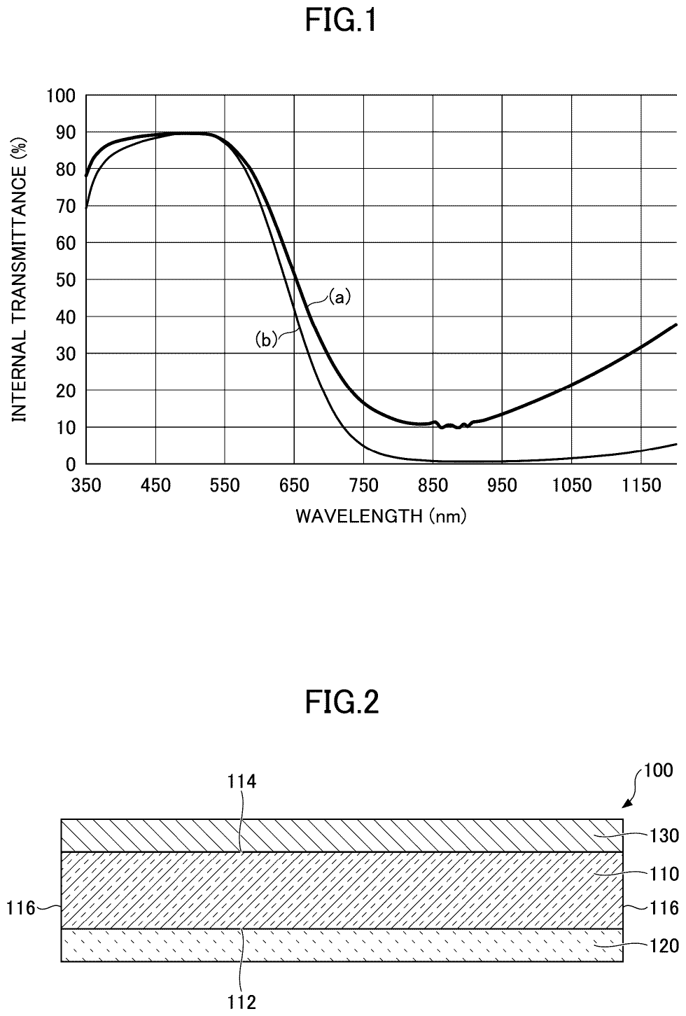

In one embodiment of the present invention, phosphate glass is used as the glass for the absorbent-containing glass substrate. FIG. 1 shows typical optical properties of fluorophosphate glass and phosphate glass containing an absorbent (CuO). In FIG. 1, the horizontal axis represents the wavelength of light and the vertical axis represents the internal transmittance. In FIG. 1, (a) represents the internal transmittance of the absorbent-containing fluorophosphate glass, and (b) represents the internal transmittance of the absorbent-containing phosphate glass.

In the present application, “internal transmittance (%)” refers to the internal transmittance when the transmittance (%) at an incidence angle of 5° is T₍₅₎ and the reflectance (%) at an incidence angle of 5° is R₍₅₎, and is represented by a following formula (3):

$$Internal transmittance ( \% ) = {T}_{( 5 )} / ( 100 - {R}_{( 5 )} ) \times 100 \qquad ( 3 )$$

As shown in FIG. 1, the absorbent-containing phosphate glass has an internal transmittance equivalent to that of the absorbent-containing fluorophosphate glass in the wavelength range from 450 to 600 nm. Therefore, even if phosphate glass is used instead of fluorophosphate glass as the glass substrate of the optical filter, a high internal transmittance can be maintained in the visible light region.

Also, as shown in FIG. 1, the absorbent-containing phosphate glass has an internal transmittance sufficiently lower than that of the absorbent-containing fluorophosphate glass in the wavelength range higher than 750 nm. Therefore, when absorbent-containing phosphate glass is used as the glass substrate of the optical filter, the light shielding performance in the infrared region can be significantly enhanced by the combination of the antireflection layer and the resin layer containing the dye without using an infrared cut film.

Furthermore, in one embodiment of the present invention, the glass substrate includes in percentage by mass of an oxide basis:
50% to 80% of P₂O₅;
5% to 20% of Al₂O₃;
4% to 20% CuO;
0.5% to 15% R(1)₂O, wherein R(1) is at least one component selected from the group consisting of Li, Na, K, Rb, and Cs; and
0% to 15% R(2)O, wherein R(2) is at least one component selected from the group consisting of Ca, Mg, Ba, Sr, and Zn.

When the glass substrate has the composition described above, the light shielding performance in the infrared region can be significantly enhanced. Simultaneously, the transmittance in the visible region can be significantly enhanced.

Further, according to one embodiment of the present invention, the optical filter includes a first antireflection layer disposed directly or indirectly on the first main surface of the glass substrate, and a resin layer, containing dye, disposed as one or more layers disposed directly or indirectly on the second main surface of the glass substrate. The dye has a maximum absorption wavelength in the wavelength range of 690 to 800 nm in the resin layer, and the thickness of the resin layer is 10 μm or less.

By setting the thickness of the resin layer containing the dye having the maximum absorption wavelength in the infrared region to 10 μm or less, the Haze value of the optical filter can be reduced, and the light shielding performance in the infrared region can be significantly enhanced while maintaining the vividness of the image.

Specifically, the Haze value of the optical filter is 2% or less. By setting the Haze value of the optical filter to 2% or less, the light shielding performance in the infrared region can be significantly enhanced while maintaining the vividness of the image.

Further, according to one embodiment of the present invention, the optical filter has spectral characteristics specified as:
(a-1) a transmittance T₍ₜ₎₄₅₀ at a wavelength of 450 nm is 80% or more at incidence angles of 0° and 50°;
(a-2) an average transmittance T₍ₜ₎ₐᵥₑ₁ in a wavelength range of 450 to 600 nm is 78% or more at incidence angles of 0° and 50°;
(a-3) a maximum transmittance T₍ₜ₎ₘₐₓ₁ in a wavelength range of 450 to 600 nm is 85% or more at incidence angles of 0° and 50°;
(a-4) a minimum wavelength λ₍ₜ₎₅₀ at which a transmittance is 50% in a wavelength range of 600 to 650 nm at incidence angles of 0° and 50°;
(a-5) the average transmittance T₍ₜ₎ₐᵥₑ₂ in the wavelength range of 750 to 1200 nm is 4.0% or less at incidence angles of 0° and 50°; and
(a-6) the maximum transmittance T₍ₜ₎ₘₐₓ₂ in the wavelength range of 1000 to 1200 nm is 15% or less at incidence angles of 0° and 50°.

By having the spectral characteristics (a-1) to (a-6), the optical filter can significantly enhance the light shielding performance in the infrared region and significantly suppress the angular dependence of the optical properties.

As a result, one embodiment of the present invention can provide an optical filter having significantly high light shielding performance in the infrared region and significantly prevent the angular dependence of the optical properties.

### (Optical Filter According to One Embodiment of the Present Invention)

An optical filter according to one embodiment of the present invention will be described below with reference to FIG. 2. FIG. 2 is a cross-sectional view schematically illustrating a configuration example of an optical filter according to one embodiment of the present invention. As shown in FIG. 2, an optical filter (hereinafter referred to as “first optical filter”) 100 according to one embodiment of the present invention has a glass substrate 110, a first antireflection layer 120, and a resin layer 130 containing dye.

The glass substrate 110 has a first main surface 112 and a second main surface 114 opposite each other. The first antireflection layer 120 is arranged directly or indirectly on the first main surface 112 of the glass substrate 110. The first main surface 112 of the glass substrate 110 may be coated with the first antireflection layer 120, and another layer may be arranged between the first main surface 112 of the glass substrate 110 and the first antireflection layer 120.

The resin layer 130 is arranged as at least one layer directly or indirectly on the second main surface 114 of the glass substrate 110. A plurality of resin layers 130 may be laminated on the second main surface 114 of the glass substrate 110. The second main surface 114 of the glass substrate 110 may be coated with the resin layer 130, and another layer may be arranged between the second main surface 114 of the glass substrate 110 and the resin layer 130.

The first main surface 112 and the second main surface 114 of the glass substrate 110 are preferably coated with an inorganic film from the viewpoint of protecting the glass substrate 110 from the outside. It is more preferable that the first main surface 112 and the second main surface 114 of the glass substrate 110 and the end surface 116 between the first main surface 112 and the second main surface 114 are coated with an inorganic film such as aluminum oxide.

### (An Optical Filter According to Another Embodiment of the Present Invention)

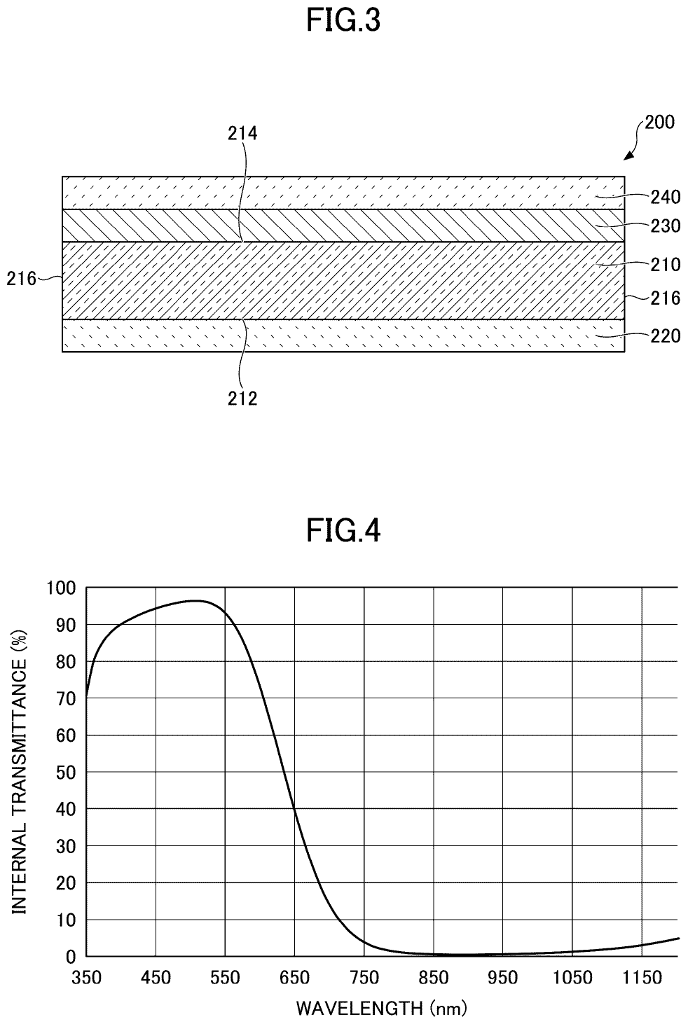

Next, an optical filter according to another embodiment of the present invention will be described with reference to FIG. 3. FIG. 3 is a cross-sectional view schematically illustrating a configuration example of an optical filter (hereinafter referred to as “second optical filter”) according to another embodiment of the present invention. As shown in FIG. 3, the second optical filter 200 has the same configuration as the first optical filter 100 described above. Accordingly, in FIG. 3, reference numerals obtained by adding 100 to the reference numerals shown in FIG. 2 are used for the members corresponding to the members included in the first optical filter 100.

For example, as shown in FIG. 3, the second optical filter 200 has a glass substrate 210, a first antireflection layer 220, and a resin layer 230 containing dye. However, in the second optical filter 200, unlike the first optical filter 100, the second antireflection layer 240 is provided directly or indirectly on the resin layer 230.

The first main surface 212 of the glass substrate 210 may be covered with the first antireflection layer 220, and another layer may be arranged between the first main surface 212 of the glass substrate 210 and the first antireflection layer 220.

The resin layer 230 is arranged at least one layer on the second main surface 214 of the glass substrate 210. A plurality of resin layers 230 may be laminated on the second main surface 214 of the glass substrate 210. The second main surface 214 of the glass substrate 210 may be covered with the resin layer 230, and another layer may be arranged between the second main surface 214 of the glass substrate 210 and the resin layer 230.

The first main surface 212 and the second main surface 214 of the glass substrate 210 are preferably covered with an inorganic film from the viewpoint of protecting the glass substrate 210 from the outside. The first main surface 212 and the second main surface 214 of the glass substrate 210 and the end surface 216 between the first main surface 212 and the second main surface 214 are more preferably covered with an inorganic film such as aluminum oxide.

### (Respective Members Included in the Optical Filter According to One Embodiment of the Present Invention)

Next, respective members constituting the optical filter according to one embodiment of the present invention will be described in more detail. Here, the constituent members will be described with reference to the first optical filter 100 shown in FIG. 2. Accordingly, the reference numerals shown in FIG. 2 will be used to denote the respective members.

### (Glass Substrate 110)

Hereinafter, the glass substrate 110 used in the optical filter according to one embodiment of the present invention will be described. In the following description, unless mentioned specially, an amount contained of each component and a total amount contained are represented in a percentage by mass on an oxide basis.

The glass substrate 110 is made of phosphate glass containing an absorbent. The glass substrate 110 includes in a percentage by mass on an oxide basis:
50% to 80% P₂O₅;
5% to 20% Al₂O₃;
4% to 20% CuO;
0.5% to 15% R(1)₂O, wherein R(1) is at least one component selected from the group consisting of Li, Na, K, Rb, and Cs; and
0% to 15% R(2)O, wherein R(2) is at least one component selected from the group consisting of Ca, Mg, Ba, Sr, and Zn.

P₂O₅ is a main component for forming the glass and is a component for enhancing near infrared ray cutting property. When the content of P₂O₅ is 50% or more, the effect can be sufficiently obtained, and when it is 80% or less, problems such as glass is unstable and weather resistance deteriorating are unlikely to occur. Therefore, the content of P₂O₅ is preferably 50-80%, more preferably 52-78%, still more preferably 54-77%, further more preferably 56-76%, and most preferably 60-75%.

Al₂O₃ is a main component for forming the glass and is a component for enhancing the strength of glass. When the content of Al₂O₃ is 5% or more, the effect can be sufficiently obtained, and when it is 20% or less, problems such as glass is unstable and near infrared ray cutting property deteriorating are unlikely to occur. Therefore, the content of Al₂O₃ is preferably 5-20%, more preferably 6-18%, still more preferably 7-17%, further more preferably 8-16%, and most preferably 9-13%. When the content of Al₂O₃ is 9% or more, the weather resistance of glass can be enhanced.

R(1)₂O is a component for lowering the melting temperature of glass, lowering the liquid phase temperature of glass, stabilizing glass, and the like. When the content of R(1)₂O is 0.5% or more, the effect can be sufficiently obtained, and when it is 20% or less, it is preferable because the glass is unlikely to be unstable. Therefore, the total amount of R(1)₂O is preferably 0.5-20%, more preferably 1-20%, still more preferably 2-20%, further more preferably 3-20%, and most preferably 4-20%.

Li₂O is a component for lowering the melting temperature of glass, lowering the liquid phase temperature of glass, stabilizing glass, and the like. The content of Li₂O is preferably 0-15%. When the content of Li₂O is 15% or less, it is preferable because problems such as instability of glass and deterioration of near-infrared cutting property are unlikely to occur. The content of Li₂O is more preferably 0-8%, still more preferably 0-7%, further more preferably 0-6%, and most preferably substantially free of Li₂O.

In the present application, substantially free of the specific component means that it is intentionally not added, and does not exclude the content of the specific component to a degree that it is unavoidably mixed from the raw material or the like and does not affect the intended characteristics.

Na₂O is a component for lowering the melting temperature of glass, lowering the liquid phase temperature of glass, stabilizing glass, and the like. The content of Na₂O is preferably 0-15%. The content of Na₂O is preferably 15% or less because the glass is unlikely to be unstable. The content of Na₂O is more preferably 0.5-14%, still more preferably 1-13%, and further more preferably 2-13%.

K₂O is a component having an effect of lowering the melting temperature of the glass, lowering the liquid phase temperature of the glass, etc. The content of K₂O is preferably 0-15%. A content of K₂O of 15% or less is preferable because the glass is unlikely to be unstable. The content of K₂O is more preferably 0.5-14%, still more preferably 1-13%, and further more preferably 2-13%.

Rb₂O is a component having effects such as lowering the melting temperature of the glass and lowering the liquid phase temperature of the glass. The content of Rb₂O is preferably 0-15%. The content of Rb₂O is preferably 15% or less because the glass is unlikely to be unstable. The content of Rb₂O is more preferably 0.5-14%, still more preferably 1-13%, and further more preferably 2-13%.

Cs₂O is a component having effects such as lowering the melting temperature of the glass and lowering the liquid phase temperature of the glass. The content of Cs₂O is preferably 0-15%. If the content of Cs₂O is 15% or less, it is preferable because the glass is unlikely to be unstable. The content of Cs₂O is more preferably 0.5-14%, still more preferably 1-13%, and further more preferably 2-13%.

R(2)O is a component for lowering the melting temperature of the glass, lowering the liquid phase temperature of the glass, stabilizing the glass, and increasing the strength of the glass. The total amount of R(2)O is preferably 0-15%. When the total amount of R(2)O is 15% or less, problems such as instability of the glass, reduction of near-infrared ray cutting property, reduction of short-wavelength infrared ray transmission, and reduction of strength of the glass are not likely to occur. The total amount of R(2)O is more preferably 0-13%, still more preferably 0-11%, further more preferably 0-9%, and further more preferably 0-8%.

CuO is a component for cutting near-infrared rays. When the content of CuO is 4% or more, the effect is sufficiently obtained. When the content is 20% or less, it is preferable because problems such as a decrease in transmittance in the visible light region and a decrease in transmittance in the short-wavelength infrared region hardly occur. The content of CuO is more preferably 4-19.5%, still more preferably 5-19%, still more preferably 6-18.5%, and still more preferably over 7%. In particular, when the glass substantially contains no divalent cations other than Cu, the CuO content is over 7%, so that the cutting property of near-infrared rays and the transmittance of short-wavelength infrared rays can be further enhanced. The content of CuO is most preferably 7-18% (but not 7%).

The glass substrate 110 preferably contains substantially no divalent cations other than Cu. The reason will be described below.

When the glass of the present embodiment contains CuO, light in the near-infrared region is cut off by the optical absorption of Cu²⁺ ions. The optical absorption is caused by the electronic transition between the d orbitals of Cu²⁺ ions split by the electric field of O²⁻ ions. The splitting of the d orbitals is promoted when the symmetry of O²⁻ ions around Cu²⁺ ions decreases. For example, when cations exist around O²⁻ ions, O²⁻ ions are attracted by the electric field of cations, and the symmetry of O²⁻ ions decreases. As a result, the splitting of the d orbitals is promoted, and the optical absorption is generated by the electronic transition between the split d orbitals, which weakens the optical absorption in the near-infrared region and enhances the optical absorption in the short-wavelength infrared region. Since the electric field strength of cations increases with the valence of ions, the addition of oxides containing divalent cations other than Cu in the glass may reduce the near-infrared cutoff and the transmittance of short-wavelength infrared rays.

CaO is a component for lowering the melting temperature of glass, lowering the liquid phase temperature of glass, stabilizing glass, and increasing the strength of glass. The content of CaO is preferably 0-10%. When the content of CaO is 10% or less, it is preferable because problems such as instability of glass, lowering of near-infrared ray cutting property, and lowering of short-wavelength infrared ray transmission are not likely to occur. It is more preferably 0-8%, still more preferably 0-6%, and further more preferably 0-5%. Most preferably, it is substantially free of CaO.

MgO is a component for lowering the melting temperature of glass, lowering the liquid phase temperature of glass, stabilizing glass, and increasing the strength of glass. The content of MgO is preferably 0-15%. When the content of MgO is 15% or less, it is preferable because problems such as instability of glass, lowering of near-infrared ray cutting property, and lowering of short-wavelength infrared ray transmission are unlikely to occur. It is more preferably 0-13%, still more preferably 0-10%, and further more preferably 0-9%. Most preferably it is substantially free of MgO.

BaO is a component for lowering the melting temperature of glass, lowering the liquid phase temperature of glass, stabilizing glass, and the like. The content of BaO is preferably 0-10%. When the content of BaO is 10% or less, it is preferable because problems such as instability of glass, lowering of near-infrared ray cutting property, and lowering of short-wavelength infrared ray transmission are unlikely to occur. It is more preferably 0-8%, still more preferably 0-6%, and further more preferably 0-5%. Most preferably, it is substantially free of BaO.

SrO is a component for lowering the melting temperature of glass, lowering the liquid phase temperature of glass, stabilizing glass, and the like. The content of SrO is preferably 0-10%. When the content of SrO is 10% or less, problems such as instability of glass, reduction of near-infrared ray cutting property, and reduction of short-wavelength infrared ray transmission are not likely to occur. It is more preferably 0-8%, and still more preferably 0-7%. Most preferably, it is substantially free of SrO.

ZnO is a component for lowering the melting temperature of glass, lowering the liquid phase temperature of glass, and the like. The content of ZnO is preferably 0-15%. When the content of ZnO is 15% or less, problems such as deterioration of fusibility of glass, reduction of near-infrared ray cutting property, and reduction of short-wavelength infrared ray transmission are not likely to occur. It is more preferably 0-13%, still more preferably 0-10%, further more preferably 0-9%. Most preferably, it is substantially free of ZnO.

The content of B₂O₃ may be 10% or less in order to stabilize the glass. If the content of B₂O₃ is 10% or less, it is preferable because problems such as deterioration of the weatherability of the glass, reduction of the near-infrared ray cutting property, and reduction of the short-wavelength infrared ray transmission are unlikely to occur. It is preferably 9% or less, more preferably 8% or less, still more preferably 7% or less, further more preferably 6% or less, and most preferably substantially free of B₂O₃.

Although F is an effective component for improving the weatherability of the glass substrate 110, it is preferable that F is substantially not contained because it is an environmental load material and may reduce the near-infrared ray cutting property.

In order to improve the weatherability of the glass substrate 110, SiO₂, GeO₂, ZrO₂, SnO₂, TiO₂, CeO₂, WO₃, Y₂O₃, La₂O₃, Gd₂O₃, Yb₂O₃, and Nb₂O₅ may be contained in a range of 5% or less. If the content of these components is 5% or less, it is preferable because problems such as a decrease in the near-infrared ray cutting property and a decrease in the short-wavelength infrared ray transmission are unlikely to occur. It is preferably 4% or less, more preferably 3% or less, still more preferably 2% or less, and further more preferably 1% or less.

Fe₂O₃, Cr₂O₃, Bi₂O₃, NiO, V₂O₅, MoO₃, MnO₂, and CoO are all components that, when present in the glass, reduce the visible transmittance. Therefore, these components are preferably substantially not contained in the glass.

The glass substrate 110 preferably has a coefficient of thermal expansion in the range of 30 to 300° C. of 60×10⁻⁷ to 180×10⁻⁷/° C.

The glass substrate 110 may have a thickness in the range of, for example, 0.1 to 3 mm.

The shape of the glass substrate 110 is not particularly limited. The first and second main surfaces 112 and 114 of the glass substrate 110 may be rectangular or elliptical (including circular). When the first and second main surfaces 112 and 114 are rectangular, the glass substrate 110 has a plurality of end surfaces 116. Additionally, when the first and second main surfaces 112 and 114 are circular, the glass substrate 110 has a single end surface 116.

The shape of the end surface 116 is not particularly limited. For example, the end surface 116 may have a shape extending in a direction substantially perpendicular to the first and second main surfaces 112 and 114, or may have any other shape. For example, the end surface 116 of the glass substrate 110 may have an inclined portion with respect to the normal line of the first main surface 112 and/or the normal line of the second main surface 114.

FIG. 4 schematically shows an example of optical properties of the glass substrate 110. In FIG. 4, the horizontal axis represents the wavelength, and the vertical axis represents the internal transmittance at an incidence angle of 5°.

As shown in FIG. 4, the glass substrate 110 has spectral characteristics specified as:
(b-1) an internal transmittance T_{(g)450} at a wavelength of 450 nm is 92% or more;
(b-2) an average internal transmittance T_{(g)ave1} in a wavelength range of 450 to 600 nm is 90% or more;
(b-3) a minimum wavelength λ_{(g)50} at which the internal transmittance is 50% in a range of 625 to 650 nm;
(b-4) an average internal transmittance T_{(g)ave2} in a wavelength range of 750 to 1000 nm is 2.5% or less;
(b-5) a maximum internal transmittance T_{(g)max} in a wavelength range of 1000 to 1200 nm is 7% or less; and the Haze value is preferably 1% or less.

When the glass substrate 110 has the spectral characteristics (b-1) to (b-5) and the Haze value is 1% or less, the light shielding performance of the first optical filter 100 in the infrared region can be significantly enhanced and the angular dependence of the optical properties can be significantly reduced while maintaining the vividness of the image. A transmittance in the visible light region can also be significantly enhanced.

### (First Antireflection Layer 120)

In the present application, the term “antireflection layer” means a layer configured to have a maximum reflectance of 45% or less for light having a wavelength between 450 and 1200 nm. The first antireflection layer preferably has a reflectance of 20% or less in a wavelength range of 450 to 750 nm.

The first antireflection layer 120 is composed of a multilayer film. The multilayer film may be composed of alternating films of high and low refractive index films. The high refractive index film may be selected from, for example, titania and alumina. The low refractive index film may be selected from, for example, silica and magnesium fluoride.

The thickness of the first antireflection layer 120 is not limited thereto, but may be in the range of, for example, 0.1 to 3 μm.

In a case of the second optical filter 200 shown in FIG. 3, the first antireflection layer 220 and the second antireflection layer 240 can have the same configuration as that of the first antireflection layer 120 of the first optical filter 100.

### (Resin Layer 130)

The resin layer 130 includes dye that absorbs infrared rays. Such dye may be selected from, for example, a squarylium dye, a phthalocyanine dye, and a cyanine dye.

The resin constituting the resin layer 130 is not particularly limited as long as it is transparent. The resin may be selected from, for example, polyester resins, acrylic resins, epoxy resins, en-thiol resins, polycarbonate resins, polyether resins, polyarylate resins, polysulfone resins, polyether sulfone resins, polyparaphenylene resins, polyarylene ether phosphine oxide resins, polyamide resins, polyimide resins, polyamideimide resins, polyolefin resins, cyclic olefin resins, polyurethane resins, polystyrene resins, and the like.

The resin is preferably selected from polyimide resin, polycarbonate resin, polyester resin, and acrylic resin from the viewpoint of spectral characteristics, glass transition temperature (Tg), and adhesion of the resin layer 130.

The glass transition temperature (Tg) of the resin is preferably 200° C. or higher from the viewpoint of heat resistance.

The resin layer 130 may contain one type of resin, or two types or more may be mixed and used.

The thickness of the resin layer 130 is 10 μm or less. The thickness of the resin layer 130 is preferably in the range of 0.3 to 10 μm. When the thickness of the resin layer 130 is 10 μm or less, the haze value of the optical filter can be reduced, and the light shielding performance in the infrared region can be significantly enhanced while the vividness of the image is maintained.

The dye has a maximum absorption wavelength in the range of 690 to 800 nm in the resin layer 130. In other words, the resin layer 130 has a maximum absorption wavelength in the range of 690 to 800 nm. Thus, when the resin layer 130 containing such dye is combined with the glass substrate 110 having the above-described composition, the internal transmittance in the infrared region can be reduced as compared with the case where only the glass substrate 110 is used. Therefore, the light shielding performance of the first optical filter 100 in the infrared region can be significantly enhanced.

For example, the squarylium dye described above may have a maximum absorption wavelength of 752 nm, and the cyanine dye may have a maximum absorption wavelength of 773 nm.

The resin layer 130 preferably has spectral characteristics specified as:
(c-1) an internal transmittance T_{(g)450} at a wavelength of 450 nm is 85% or more;
(c-2) an average internal transmittance T_{(g)ave1} in a wavelength range of 450 to 600 nm is 90% or more; and
(c-3) The minimum wavelength λ_{(g)50} at which the internal transmittance is 50% is in the range of 660 to 700 nm.

Since the resin layer 130 has the above spectral characteristics (c-1) to (c-3), when combined with the glass substrate 110 having the above composition, the light shielding performance of the first optical filter 100 in the infrared region can be further significantly enhanced.

When the internal transmittance calculated from the above formula (3) is Y, an absorbance is expressed by the following formula (4):

$$Absorbance = - log 10 ( Y / 100 ) . \qquad ( 4 )$$

The resin layer 130 preferably satisfies the following relational expression, where the absorbance at a wavelength of 450 nm is referred to as A1, the absorbance at a wavelength of 500 nm is referred to as A2, the absorbance at a wavelength of 550 nm is referred to as A3, and the absorbance at a wavelength of 600 nm is referred to as A4.

$$0 < A 2 / A 1 \\ A 3 / A 2 > 1 \\ A 4 / A 3 > 1$$

Since the absorbance of the resin layer 130 satisfies the above relational expression, when the resin layer is combined with the glass substrate 110 having the above composition, the light shielding performance of the first optical filter 100 in the infrared region can be further significantly enhanced.

Furthermore, the resin layer 130 may have dye that absorbs light in an ultraviolet region. Such dye may be, for example, a merocyanine dye (maximum absorption wavelength 397 nm). Since the resin layer 130 has dye that absorbs light in the ultraviolet region, the internal transmittance of the ultraviolet region can be sufficiently suppressed.

FIG. 5 schematically shows an example of an absorption spectrum of the resin layer 130 (precisely, the dye contained in the resin layer 130). In FIG. 5, the horizontal axis represents the wavelength, and the vertical axis represents the internal transmittance. The resin layer 130 includes a merocyanine dye, a cyanine dye, and a squarylium dye as the dyes.

As shown in FIG. 5, in the present example, the resin layer 130 exhibits a large absorption in a region of approximately 400 nm wavelength and a region of approximately 750 nm wavelength.

### (First Optical Filter 100)

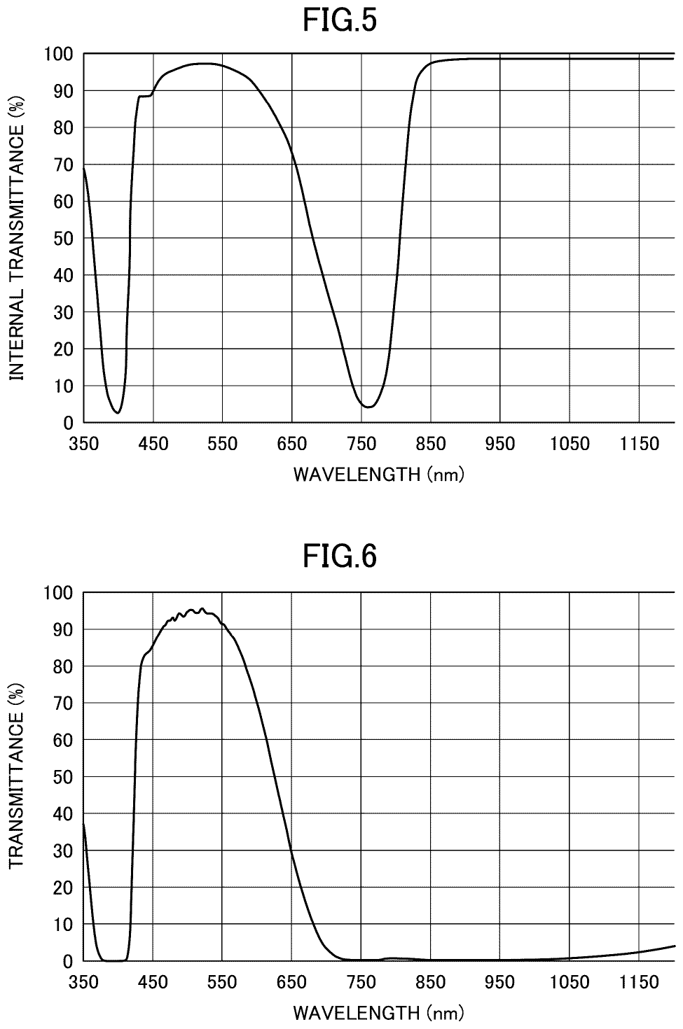

FIG. 6 schematically shows an example of the optical properties of the first optical filter 100. In FIG. 6, the horizontal axis represents wavelength and the vertical axis represents transmittance.

FIG. 6 shows a change in transmittance at an incidence angle 0°. However, in the case of the first optical filter 100, the optical properties do not change much at an incidence angle 50°.

The first optical filter 100 has spectral characteristics specified as:
(a-1) a transmittance T₍ₜ₎₄₅₀ at a wavelength of 450 nm is 80% or more at incidence angles of 0° and 50°;
(a-2) an average transmittance T₍ₜ₎ₐᵥₑ₁ in a wavelength range of 450 to 600 nm is 78% or more at incidence angles of 0° and 50°;
(a-3) a maximum transmittance T₍ₜ₎ₘₐₓ₁ in a wavelength range of 450 to 600 nm is 85% or more at incidence angles of 0° and 50°;
(a-4) a minimum wavelength λ₍ₜ₎₅₀ at which a transmittance is 50% in a wavelength range of 600 to 650 nm at incidence angles of 0° and 50°;
(a-5) an average transmittance T₍ₜ₎ₐᵥₑ₂ in a wavelength range of 750 to 1200 nm is 4.0% or less at incidence angles of 0° and 50°; and
(a-6) a maximum transmittance T₍ₜ₎ₘₐₓ₂ in a wavelength range of 1000 to 1200 nm is 15% or less at incidence angles of 0° and 50°.

When the first optical filter 100 has the spectral characteristics (a-1) to (a-6) described above, the light shielding performance in the infrared region can be significantly enhanced and the angular dependence of the optical properties can be significantly reduced.

Further, when light is incident from the direction of the first main surface 112 of the glass substrate 110, the first optical filter 100 preferably has spectral characteristics specified as:
(a-7) the maximum reflectance R₍ₜ₎ₘₐₓ₁ at the wavelength range of 450 to 700 nm is 7% or less at incidence angles of 5° and 50°; and
(a-8) the maximum reflectance R₍ₜ₎ₘₐₓ₂ at the wavelength range of 700 to 1200 nm is 45% or less at incidence angles of 5° and 50°.

By having the spectral characteristics (a-7) to (a-8) described above, the first optical filter 100 can significantly enhance the light shielding performance in the infrared region and more significantly reduces the angular dependence of the optical properties.

The Haze value of the first optical filter 100 is 2% or less. When the Haze value of the first optical filter 100 is 2% or less, the light shielding performance in the infrared region can be significantly enhanced while the vividness of the image is maintained.

When the transmittance (%) is T and the reflectance (%) is R, absorptivity is expressed by the following formula (1):

$$Absorptivity ( \% ) = 100 - T - R . \qquad ( 1 )$$

The absorptivity expressed by the formula (1) is, in other words, a loss ratio of the transmittance due to absorption in the optical filter.

When light is incident from the direction of the first main surface 112 of the glass substrate 110, The first optical filter 100 preferably has spectral characteristics specified as:
(a-9) an average absorptivity is 15% or less at an incidence angle 0° and a reflection angle of 5° in a wavelength range of 450 to 600 nm; and
(a-10) the average absorptivity is 88% or more at the incidence angle 0° and the reflection angle 5°.

Since the first optical filter 100 has the spectral characteristics (a-9) to (a-10) described above, the reflectance becomes smaller as the Haze value becomes smaller, and the absorptivity becomes closer to 100−T₍₅₎ as the reflectance becomes smaller. That is, the light shielding performance in the infrared region is not caused by reflection but by absorption. Therefore, the light shielding performance in the infrared region can be more significantly enhanced while maintaining the vividness of the image.

The first optical filter 100 preferably has spectral characteristics specified as:
(a-11) a difference between the average absorptivity at the incidence angle 0° and the reflection angle 5° and the average absorptivity at the incidence angle 50° and the reflection angle 50° in the wavelength range of 450 to 600 nm is 3% or less; and
(a-12) a difference between the average absorptivity at the incidence angle 0° and the reflection angle 5° and the average absorptivity at the incidence angle 50° and the reflection angle 50° in the wavelength range of 600 to 1200 nm is 5% or less.

By having the spectral characteristics (a-11) to (a-12) described above, the first optical filter 100 can more significantly enhance the light shielding performance in the infrared region and more significantly reduce the angular dependence of the optical properties while maintaining the vividness of the image.

When the absorptivity calculated from the above formula (1) is represented by X, the absorbance is represented by the following formula (2):

$$Absorptivity = - log 10 ( X / 100 ) . \qquad ( 2 )$$

The first optical filter 100 preferably satisfies the following relational expression, where B1 is the absorbance at a wavelength of 450 nm, B2 is the absorbance at a wavelength of 500 nm, B3 is the absorbance at a wavelength of 550 nm, and B4 is the absorbance at a wavelength of 600 nm at an incidence angle 0° and a reflection angle 5°.

$$1 < B 2 / B 1$$

$$0 < B 3 / B 2 < 1$$

$$0 < B 4 / B 3 < 1$$

By satisfying the above relational expression, the first optical filter 100 can more significantly enhance the light shielding performance in the infrared region. Further, since the minimum value of the absorbance of the first optical filter 100 is in a green band, it is possible to have spectral characteristics closer to human visual perception.

### (Method of Manufacturing Optical Filter According to One Embodiment of the Present Invention)

Next, an example of a method of manufacturing an optical filter according to one embodiment of the present invention will be described.

The method of manufacturing an optical filter according to one embodiment of the present invention (hereinafter, referred to as the “first method”) includes a step of preparing a glass substrate having a predetermined dimension (step S110), and a step of providing a first antireflection layer on the first main surface of the glass substrate and a resin layer on the second main surface of the glass substrate (step S120).

Hereinafter, each step will be described. Here, a method of manufacturing the first optical filter 100 will be described by way of example. Accordingly, reference numerals shown in FIG. 2 will be used to denote each member.

### (Step S110)

First, a glass substrate is prepared. As described above, the glass substrate 110 has a first main surface 112, a second main surface 114, and an end surface 116 and is made of phosphate glass having the aforementioned composition.

### (Step S120)

A first antireflection layer 120 is provided on the first main surface 112 of the glass substrate 110, and a resin layer 130 containing dye is provided on the second main surface 114. The resin layer 130 is formed from a resin solution containing dye. The resin solution may be prepared by dissolving the dye in a solution containing a resin, an organic solvent, and a silane coupling agent. The dye may include an infrared absorbing dye and an ultraviolet absorbing dye as described above. The resin layer 130 is coated by a coating method such as a spin coating method. Then, the coating film is dried to form the resin layer 130.

In the case of the second optical filter 200, further step 130 may be performed.

### (Step 130)

A second antireflection layer 240 is provided directly or indirectly on the resin layer 230.

As described above, the first antireflection layer 120 and the second antireflection layer 240 are composed of a plurality of films. The first antireflection layer 120 and the second antireflection layer 240 may be formed by alternately forming a high refractive index film and a low refractive index film. The method of forming the first antireflection layer 120 and the second antireflection layer 240 is not particularly limited. For example, a general film forming method such as a sputtering method may be used.

A step S140 may be provided between the steps S110 and S120.

### (Step S140)

An inorganic film is provided on the first main surface 112 and the second main surface 114 of the glass substrate 110. The inorganic film may be made of, for example, alumina. The method of forming the inorganic film is not particularly limited. The inorganic film may be formed by, for example, vapor deposition or sputtering.

The optical filter according to one embodiment of the present invention can be applied to an imaging apparatus such as a digital still camera. The imaging apparatus having the optical filter according to one embodiment of the present invention can provide good color reproducibility.

The imaging apparatus having the optical filter according to one embodiment of the present invention further includes a solid-state imaging device and an imaging lens, and the optical filter may be disposed, for example, between the imaging lens and the solid-state imaging device. The optical filter according to one embodiment of the present invention may be directly attached to the solid-state imaging device and/or the imaging lens of the imaging apparatus via an adhesive layer, for example.

### EXAMPLES

Examples of the present invention will be described below. In the following description, Examples 1 and 2 are examples.

First, a glass plate was cut in a full cut by the blade dicing method, and glass substrates A and B having a length of 76 mm×width of 76 mm×thickness of 0.28 mm used in examples 1 and 2 were prepared. Phosphate glass having the composition shown in Table 1 was used as the glass substrates A and B, respectively.

TABLE 1

| Composition | | |
|---|---|---|
| (mass %) | Glass Substrate A | Glass Substrate B |
| P₂O₅ | 70 | 68 |
| Al₂O₃ | 13 | 11 |
| Li₂O | 1 | — |
| Na₂O | 1 | 3 |
| K₂O | 1 | 6 |
| Rb₂O | — | — |
| Cs₂O | — | — |
| CaO | — | — |
| SrO | — | — |
| MgO | 1 | 4 |
| BaO | 3 | — |
| ZnO | 5 | — |
| CuO | 5 | 8 |
| F | — | — |
| Total | 100 | 100 |

The optical properties of the glass substrates A and B used are shown in FIG. 4. Table 2 below shows various parameters calculated from the measured optical properties.

TABLE 2

| | Glass | Glass |
|---|---|---|
| Optical Parameters | Substrate A | Substrate B |
| Internal Transmittance T_{(g)450} | 95.7 | 94.6 |
| at Wavelength of 450 nm (%) | | |
| Average Internal Transmittance | 92.4 | 92.1 |
| T_{(g)ave1} in Wavelength Range of | | |
| 450-600 nm (%) | | |
| Minimum Wavelength λ_{(g)50} | 629 | 634 |
| at which Internal Transmittance | | |
| is 50% (nm) | | |
| Average Internal Transmittance | 1.9 | 0.8 |
| T_{(g)ave2} in Wavelength Range of | | |
| 750-1000 nm (%) | | |
| Maximum Internal Transmittance | 6.4 | 2.2 |
| T_{(g)max} in Wavelength Range of | | |
| 1000-1200 nm (%) | | |

The Haze values of the glass substrate A and the glass substrate B were 0.1 or less when measured using an automatic haze meter (TC-HIIIDPK) manufactured by Tokyo Denshoku co., Ltd. in accordance with JIS K7136.

### Example 1

A first antireflection layer was formed on the first main surface of the glass substrate A by vapor deposition. The first antireflection layer was an alternating film of a silica film and a titania film. The thickness of the first antireflection layer was 200 nm. Table 3 below shows the configuration of the first antireflection layer.

TABLE 3

| Film No. | Material | Thickness (nm) |
|---|---|---|
| 1 | SiO₂ | 105 |
| 2 | TiO₂ | 15.39 |
| 3 | SiO₂ | 52.54 |
| 4 | TiO₂ | 26.43 |
| 5 | SiO₂ | 62.77 |
| 6 | TiO₂ | 17.77 |
| 7 | SiO₂ | 105.5 |
| 8 | TiO₂ | 9 |
| 9 | SiO₂ | 89.55 |
| 10 | TiO₂ | 25.12 |
| 11 | SiO₂ | 30.05 |
| 12 | TiO₂ | 82.18 |
| 13 | SiO₂ | 13.23 |
| 14 | TiO₂ | 32.78 |
| 15 | SiO₂ | 109.08 |

In Table 3, the first film is the film closest to the first main surface of the glass substrate A, and the second film, the third film, and the 15th film are arranged in the order of proximity from the first main surface.

Next, a liquid for the resin layer was prepared. The liquid for the resin layer was prepared as follows.

First, polyimide varnish C3G30G (manufactured by Mitsubishi Gas Chemical Company, Inc.) was diluted with cyclohexanone and γ-butyrolactone so that the resin solid content was 8.5 wt %. Compound A, Compound B, and Compound C were added as dyes to the diluted solution to prepare a liquid for a resin layer. The amounts of Compound A, Compound B, and Compound C added were 2.33 mass %, 6.08 mass %, and 2.56 mass %, respectively, with respect to the resin.

The specifications for Compound A, Compound B, and Compound C are summarized in Table 4 below.

TABLE 4

| | Maximum Absorption | |
|---|---|---|
| Compound | Wavelength | Dye Classification |
| A | 752 nm | Squarylium Dye |
| B | 397 nm | Merocyanine Dye |
| C | 773 nm | Cyanine Dye |

Compound A, Compound B, and Compound C each have the following general formula.

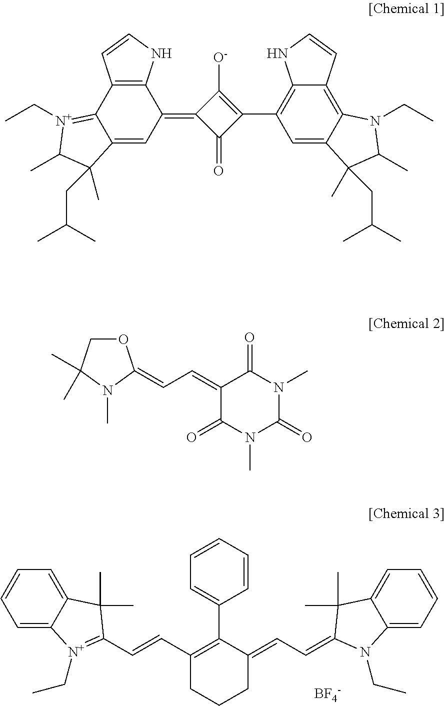

Next, a resin layer liquid was spin-coated on the second main surface of the glass substrate A. The target thickness was 1 μm. Then, the resin layer liquid was dried to form a resin layer. This resin layer has optical properties as shown in FIG. 5.

Next, a second antireflection layer was formed directly or indirectly on the resin layer. The second antireflection layer had the same structure as the first antireflection layer and was formed by vapor deposition. Thus, an optical filter (hereinafter referred to as “optical filter 1”) was obtained.

### Example 2

A first alumina film was formed on the first main surface of the glass substrate B by vapor deposition. The target thickness of the first alumina film was 143 nm. Next, a second alumina film was formed on the first main surface of the glass substrate B. The target thickness of the second alumina film was 143 nm.

Next, a first antireflection layer was formed on the first alumina film by vapor deposition. The structure and thickness of the first antireflection layer were the same as in Example 1.

Next, a resin layer liquid was spin coated on the second alumina film of the glass substrate B. The same resin layer liquid as in Example 1 was used. The target thickness of the resin layer was 1 μm. Then, the resin layer liquid was dried to form the same resin layer as in Example 1.

Next, as in Example 1, a second antireflection layer was formed directly or indirectly on the resin layer. Thus, an optical filter (hereinafter, referred to as “optical filter 2”) was obtained.

### (Evaluation)

The following evaluations were performed using each optical filter.

### (Measurement of Haze Value)

The Haze value was measured for each optical filter in accordance with JIS K7136. The Haze value of both optical filter 1 and optical filter 2 was 1% or less.

### (Evaluation of Optical Properties)

The optical properties were evaluated using each optical filter. An ultraviolet-visible near-infrared spectrophotometer (UH4150, manufactured by Hitachi High-Tech Corporation) was used for the measurement. In the case of measurement of transmittance, light was incident from the side of the first anti-reflection layer in each optical filter at incidence angles of 0° and 50°. Additionally, in the case of measurement of reflectance, light was incident from the direction of the first anti-reflection layer in each optical filter at incidence angles of 5° and 50°.

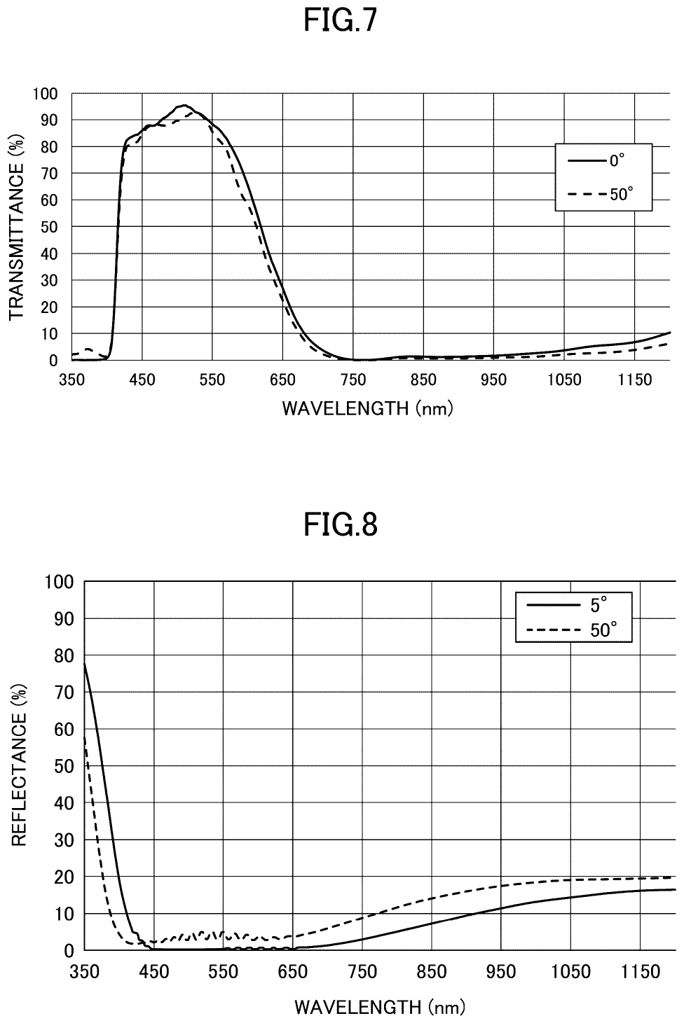

FIG. 7 shows an example of the transmittance profile obtained in the optical filter 1. In FIG. 7, the horizontal axis is the wavelength and the vertical axis is the transmittance. FIG. 7 shows the results at incidence angles of 0° and 50° together.

As shown in FIG. 7, it can be seen that in the optical filter 1, the influence of the incidence angle on the transmittance profile is hardly observed. That is, in the visible light region, high transmittance was obtained regardless of the incidence angle. In addition, even if the incidence angle changes, the region where the transmittance rapidly decreases hardly changes. Moreover, it was found that the transmittance is low in the infrared region regardless of the incidence angle.

FIG. 8 shows an example of the reflectance profile obtained in the optical filter 1. In FIG. 8, the horizontal axis represents the wavelength and the vertical axis represents the reflectance. FIG. 8 shows the results at the incidence angles of 5° and 500.

As shown in FIG. 8, it can be seen that the incidence angle has little effect on the reflectance profile in the optical filter 1.

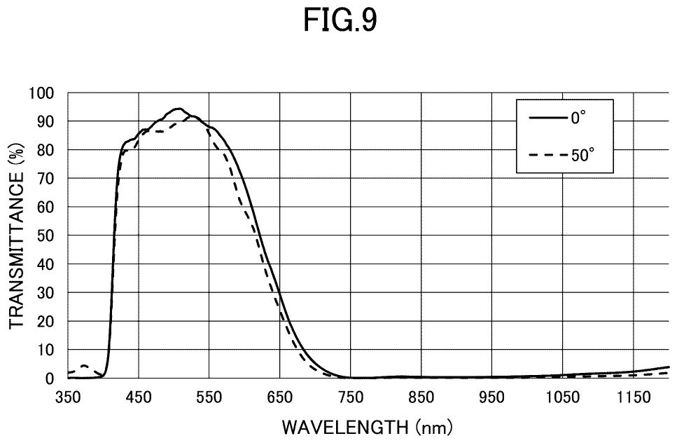

FIG. 9 shows an example of the transmittance profile obtained in the optical filter 2. In FIG. 9, the horizontal axis represents the wavelength, and the vertical axis represents the transmittance. In FIG. 9, the results at incidence angles of 0° and 50° are shown together.

As shown in FIG. 9, the optical filter 2 obtained the same results as the optical filter 1. That is, high transmittance was obtained in the visible light region regardless of the incidence angle. Moreover, even if the incidence angle changed, the region in which the transmittance rapidly decreased hardly changed. Moreover, it was found that the transmittance was low in the infrared region regardless of the incidence angle.

The parameters related to the transmittance profiles measured in the optical filter 1 and the optical filter 2 are summarized in Table 5 below.

TABLE 5

| | Optical Filter 1 | | Optical Filter 2 | |
|---|---|---|---|---|
| | Incidence Angle | | Incidence Angle | |
| | (°) | | (°) | |
| Optical Parameters | 0 | 50 | 0 | 50 |
| Transmittance T₍ₜ₎₄₅₀ | 86.0 | 84.4 | 85.6 | 83.2 |
| at Wavelength of 450 nm (%) | | | | |
| Average Transmittance T₍ₜ₎ₐᵥₑ₁ | 87.4 | 83.9 | 87.3 | 83.3 |
| in Wavelength Range of | | | | |
| 450-600 nm (%) | | | | |
| Maximum Transmittance T₍ₜ₎ₘₐₓ₁ | 95.3 | 92.4 | 94.3 | 91.4 |
| in Wavelength Range of | | | | |
| 450-600 nm (%) | | | | |
| Minimum Wavelength λ₍ₜ₎₅₀ | 619 | 613 | 622 | 616 |
| at which Internal | | | | |
| Transmittance is 50% (nm) | | | | |
| Average Transmittance T₍ₜ₎ₐᵥₑ₂ | 3.1 | 1.7 | 1.0 | 0.4 |
| in Wavelength Range of | | | | |
| 750-1200 nm (%) | | | | |
| Maximum Transmittance T₍ₜ₎ₘₐₓ₂ | 10.3 | 6.2 | 3.9 | 1.9 |
| in Wavelength Range of | | | | |
| 1000-1200 nm (%) | | | | |

Table 6 below summarizes the reflectance profile parameters measured in optical filter 1 and optical filter 2.

TABLE 6

| | Optical Filter 1 | | Optical Filter 2 | |
|---|---|---|---|---|
| | Incidence Angle | | Incidence Angle | |
| | (°) | | (°) | |
| Optical Parameters | 5 | 50 | 5 | 50 |
| Maximum Reflectance R₍ₜ₎ₘₐₓ₁ | 4.9 | 6.6 | 4.0 | 6.2 |
| in Wavelength Range of | | | | |
| 450-700 nm (%) | | | | |
| Maximum Reflectance R₍ₜ₎ₘₐₓ₂ | 9.3 | 20.9 | 9.0 | 20.8 |
| in Wavelength Range of | | | | |
| 700-1200 nm (%) | | | | |

Table 7 below summarizes the absorptance profile parameters measured and calculated in optical filter 1 and optical filter 2.

TABLE 7

| | Optical | Optical |
|---|---|---|
| Optical Parameters | Filter 1 | Filter 2 |
| Average Absorptivity at | 12.0 | 12.6 |
| Incidence Angle 50°, | | |
| Reflection Angle 50°, in Wavelength | | |
| Range of 450-600 nm (C) (%) | | |
| Average Absorptivity at | 88.0 | 88.7 |
| Incidence Angle 50°, | | |
| Reflection Angle 50°, in Wavelength | | |
| Range of 600-1200 nm (C) (%) | | |
| Average Absorptivity at | 10.7 | 10.8 |
| Incidence Angle 0°, | | |
| Reflection Angle 5°, in Wavelength | | |
| Range of 450-600 nm (D) (%) | | |
| Average Absorptivity at | 90.4 | 91.7 |
| Incidence Angle 0°, | | |
| Reflection Angle 5°, in Wavelength | | |
| Range of 600-1200 nm (D) (%) | | |
| \|C − D\| in Wavelength Range of | 1.3 | 1.8 |
| 450−600 nm (%) | | |
| \|C − D\| in Wavelength Range of | 2.5 | 3.0 |
| 600-1200 nm (%) | | |

Table 8 below summarizes the parameters related to the absorbance profiles measured and calculated by the optical filters 1 and 2.

TABLE 8

| | Optical | Optical |
|---|---|---|
| Optical Parameters | Filter 1 | Filter 2 |
| Absorbance at Incidence Angle 0°, | 0.90 | 0.90 |
| Reflection Angle 5°, | | |
| at Wavelength of 450 nm (B1) | | |
| Absorbance at Incidence Angle 0°, | 1.34 | 1.25 |
| Reflection Angle 5°, | | |
| at Wavelength of 500 nm (B2) | | |
| Absorbance at Incidence Angle 0°, | 1.07 | 1.04 |
| Reflection Angle 5°, | | |
| at Wavelength of 550 nm (B3) | | |
| Absorbance at Incidence Angle 0°, | 0.47 | 0.50 |
| Reflection Angle 5°, | | |
| at Wavelength of 600 nm (B4) | | |
| B2/B1 | 0.44 | 1.39 |
| B3/B2 | 0.80 | 0.83 |
| B4/B3 | 1.49 | 0.48 |

Thus, it was confirmed that the optical properties of the optical filters 1 and 2 hardly changed even if the incidence angle changed. It was also confirmed that the optical filters 1 and 2 had excellent light absorption ability in the infrared region and sufficiently shielded the infrared rays. Furthermore, it was confirmed that the Haze value was low in the optical filters 1 and 2 and that there was no problem in the vividness of the images obtained by the optical filters 1 and 2.

### Aspects of the Present Invention

The present invention includes the following aspects.

### Aspect 1

An optical filter including:
a glass substrate having a first main surface and a second main surface opposite each other and including phosphoric acid glass;
a first antireflective layer disposed directly or indirectly on the first main surface of the glass substrate; and
a resin layer, containing dye, disposed as one or more layers directly or indirectly on the second main surface of the glass substrate,
wherein the glass substrate includes, in a percentage by mass on an oxide basis:
50 to 80% of P₂O₅;
5 to 20% of Al₂O₃;
4 to 20% of CuO;
0.5 to 15% of R(1)₂O, wherein R(1) is at least one component selected from a group consisting of Li, Na, K, Rb, and Cs; and
0 to 15% of R(2)O, wherein R(2) is at least one component selected from the group consisting of Ca, Mg, Ba, Sr, and Zn,
wherein the dye has a maximum absorption wavelength in the resin layer at a wavelength range of 690 to 800 nm,
wherein a thickness of the resin layer is 10 μm or less,
wherein the optical filter has spectral characteristics specified as:
(a-1) a transmittance T₍ₜ₎₄₅₀ at a wavelength of 450 nm is 80% or more at incidence angles of 0° and 50°;
(a-2) an average transmittance T₍ₜ₎ₐᵥₑ₁ in a wavelength range of 450 to 600 nm is 78% or more at incidence angles of 0° and 50°;
(a-3) a maximum transmittance T₍ₜ₎ₘₐₓ₁ in the wavelength range of 450 to 600 nm is 85% or more at incidence angles of 0° and 50°;
(a-4) a minimum wavelength λ₍ₜ₎₅₀ at which the transmittance is 50% is in a range of 600 to 650 nm at incidence angles of 0° and 50°;
(a-5) an average transmittance T₍ₜ₎ₐᵥₑ₂ in a wavelength range of 750 to 1200 nm is 4.0% or less at incidence angles of 0° and 50°; and
(a-6) a maximum transmittance T₍ₜ₎ₘₐₓ₂ in a wavelength range of 1000 to 1200 nm is 15% or less at incidence angles of 0° and 50°, and
wherein a Haze value of the optical filter is 2% or less.

### Aspect 2

The optical filter according to aspect 1, wherein when light is incident from a direction of the first main surface of the glass substrate, the optical filter has spectral characteristics specified as:
(a-7) a maximum reflectance R(t)max in a wavelength range of 450 to 700 nm is 7% or less at incidence angles of 5° and 50°; and
(a-8) a maximum reflectance R₍ₜ₎ₘₐₓ₂ in a wavelength range of 700 to 1200 nm is 45% or less at incidence angles of 5° and 50°.

### Aspect 3

The optical filter according to aspect 1 or 2, wherein a second antireflective layer is disposed directly or indirectly on the second main surface of the glass substrate.

### Aspect 4

The optical filter according to aspect 3, wherein:
the second main surface of the glass substrate is coated with the resin layer;
the resin layer has a maximum absorption wavelength in a wavelength range of 650 to 850 nm; and
the second antireflective layer is disposed directly or indirectly on the resin layer.

### Aspect 5

The optical filter according to any one of aspects 1 to 4, wherein when transmittance (%) is referred to as T and reflectance (%) is referred to as R, absorptivity is expressed by a following formula (1):

$$Absorptivity ( \% ) = 100 - T - R , \qquad ( 1 )$$

wherein when light is incident from a direction of the first main surface of the glass substrate, the optical filter has spectral characteristics specified as:
(a-9) an average absorptivity of 15% or less at an incidence angle of 0° and a reflection angle of 5° in a wavelength range of 450 to 600 nm; and
(a-10) an average absorptivity of 88% or more at an incidence angle of 0° and a reflection angle of 5° in a wavelength range of 600 to 1200 nm.

### Aspect 6

The optical filter according to aspect 5 having spectral characteristics specified as:
(a-11) a difference between an average absorptivity at an incidence angle of 0° and a reflection angle of 5° and an average absorptivity at an incidence angle of 50° and a reflection angle of 50° in a wavelength range of 450 to 600 nm is 3% or less; and
(a-12) a difference between the average absorptivity at the incidence angle of 0° and the reflection angle of 5° and the average absorptivity at the incidence angle of 50° and the reflection angle of 50° in the wavelength range of 600 to 1200 nm is 5% or less.

### Aspect 7

The optical filter according to any one of aspects 1 to 6, wherein:
when the absorptivity calculated from the formula (1) is referred to as X, an absorbance is expressed by a following formula (2):

$$Absorbance = - log 10 ( X / 100 ) ; \qquad ( 2 )$$

when the optical filter satisfies the following relational expression, where B1 is an absorbance at a wavelength of 450 nm, B2 is an absorbance at a wavelength of 500 nm, B3 is an absorbance at a wavelength of 550 nm, and B4 is an absorbance at a wavelength of 600 nm at an incidence angle of 0° and a reflection angle of 5°.

$$1 < B 2 / B 1$$

$$0 < B 3 / B 2 < 1$$

$$0 < B 4 / B 3 < 1$$

### Aspect 8

The optical filter according to any one of aspects 1 to 7, wherein when transmittance (%) at an incidence angle of 5° is referred to as T₍₅₎ and reflectance (%) at an incidence angle of 5° is referred to as R₍₅₎, internal transmittance is expressed by a following formula (3):

$$Internal Transmittance ( \% ) = {T}_{( 5 )} / ( 100 - {R}_{( 5 )} ) \times 100 , \qquad ( 3 )$$

wherein the glass substrate has spectral characteristics specified as:
(b-1) an internal transmittance T_{(g)450} at a wavelength of 450 nm is 92% or more;
(b-2) an average internal transmittance T_{(g)ave1} in a wavelength range of 450 to 600 nm is 90% or more;
(b-3) a minimum wavelength λ_{(g)50} at which the internal transmittance is 50% is in a wavelength range of 625 to 650 nm;
(b-4) an average internal transmittance T_{(g)ave2} in a wavelength range of 750 to 1000 nm is 2.5% or less; and
(b-5) a maximum internal transmittance T_{(g)max} in a wavelength range of 1000 to 1200 nm is 7% or less, and
wherein a Haze value of the glass substrate is 1% or less.

### Aspect 9

The optical filter according to any one of aspects 1 to 8, wherein when transmittance (%) at an incidence angle of 5° is referred to as T₍₅₎ and reflectance (%) at an incidence angle of 5° is referred to as R₍₅₎, internal transmittance is expressed by a following formula (3):

$$Internal Transmittance ( \% ) = {T}_{( 5 )} / ( 100 - {R}_{( 5 )} ) \times 100 , \qquad ( 3 )$$

wherein the resin layer has spectral characteristics specified as:
(c-1) an internal transmittance T_{(g)450} at a wavelength of 450 nm is 85% or more;
(c-2) an average internal transmittance T_{(g)ave1} in a wavelength range of 450 to 600 nm is 90% or more; and
(c-3) a minimum wavelength λ_{(g)50} at which the internal transmittance is 50% is in a wavelength range from 660 to 700 nm.

### Aspect 10

The optical filter according to any one of aspects 1 to 9, wherein:
when the internal transmittance calculated from the formula (3) is referred to as Y, absorbance is expressed by a following formula (4):

$$Absorbance = - log 10 ( Y / 100 ) ; \qquad ( 4 )$$

when the optical filter satisfies the following relational expression, where the absorbance at a wavelength of 450 nm is referred to as A1, the absorbance at a wavelength of 500 nm is referred to as A2, the absorbance at a wavelength of 550 nm is referred to as A3, and the absorbance at a wavelength of 600 nm is referred to as A4.

$$0 < A 2 / A 1$$

$$A 3 / A 2 > 1$$

$$A 4 / A 3 > 1$$

### Aspect 11

The optical filter according to any one of aspects 1 to 10, wherein the first main surface and the second main surface of the glass substrate are coated with an inorganic film.

### Aspect 12

An imaging apparatus having the optical filter of any one of aspects 1 to 11.

What is claimed:

1. An optical filter comprising:
a glass substrate having a first main surface and a second main surface opposite each other and including phosphoric acid glass;
a first antireflective layer disposed directly or indirectly on the first main surface of the glass substrate; and
a resin layer, containing dye, disposed as one or more layers directly or indirectly on the second main surface of the glass substrate,
wherein the glass substrate includes, in a percentage by mass on an oxide basis:
50 to 80% of P₂O₅;
5 to 20% of Al₂O₃;
4 to 20% of CuO;
0.5 to 15% of R(1)₂O, wherein R(1) is at least one component selected from a group consisting of Li, Na, K, Rb, and Cs; and
0 to 15% of R(2)O, wherein R(2) is at least one component selected from the group consisting of Ca, Mg, Ba, Sr, and Zn,
wherein the dye has a maximum absorption wavelength in the resin layer at a wavelength range of 690 to 800 nm,
wherein a thickness of the resin layer is 10 μm or less,
wherein the optical filter has spectral characteristics specified as:
(a-1) a transmittance T₍ₜ₎₄₅₀ at a wavelength of 450 nm is 80% or more at incidence angles of 0° and 500;
(a-2) an average transmittance T₍ₜ₎ₐᵥₑ₁ in a wavelength range of 450 to 600 nm is 78% or more at incidence angles of 0° and 50°;
(a-3) a maximum transmittance T₍ₜ₎ₘₐₓ₁ in the wavelength range of 450 to 600 nm is 85% or more at incidence angles of 0° and 50°;
(a-4) a minimum wavelength λ₍ₜ₎₅₀ at which the transmittance is 50% is in a range of 600 to 650 nm at incidence angles of 0° and 50°;
(a-5) an average transmittance T₍ₜ₎ₐᵥₑ₂ in a wavelength range of 750 to 1200 nm is 4.0% or less at incidence angles of 0° and 50°; and
(a-6) a maximum transmittance T₍ₜ₎ₘₐₓ₂ in a wavelength range of 1000 to 1200 nm is 15% or less at incidence angles of 0° and 50°, and
wherein a Haze value of the optical filter is 2% or less.

2. The optical filter according to claim 1, wherein when light is incident from a direction of the first main surface of the glass substrate, the optical filter has spectral characteristics specified as:
(a-7) a maximum reflectance R₍ₜ₎ₘₐₓ₁ in a wavelength range of 450 to 700 nm is 7% or less at incidence angles of 5° and 50°; and
(a-8) a maximum reflectance R₍ₜ₎ₘₐₓ₂ in a wavelength range of 700 to 1200 nm is 45% or less at incidence angles of 5° and 50°.

3. The optical filter according to claim 1, wherein a second antireflective layer is disposed directly or indirectly on the second main surface of the glass substrate.

4. The optical filter according to claim 3, wherein:
the second main surface of the glass substrate is coated with the resin layer;
the resin layer has a maximum absorption wavelength in a wavelength range of 650 to 850 nm; and
the second antireflective layer is disposed directly or indirectly on the resin layer.

5. The optical filter according to claim 3, wherein when transmittance (%) is referred to as T and reflectance (%) is referred to as R, absorptivity is expressed by a following formula (1):
$$Absorptivity ( \% ) = 100 - T - R , \qquad ( 1 )$$
wherein when light is incident from a direction of the first main surface of the glass substrate, the optical filter has spectral characteristics specified as:
(a-9) an average absorptivity of 15% or less at an incidence angle of 0° and a reflection angle of 5° in a wavelength range of 450 to 600 nm; and
(a-10) an average absorptivity of 88% or more at an incidence angle of 0° and a reflection angle of 5° in a wavelength range of 600 to 1200 nm.

6. The optical filter according to claim 5 having spectral characteristics specified as:
(a-11) a difference between an average absorptivity at an incidence angle of 0° and a reflection angle of 5° and an average absorptivity at an incidence angle of 50° and a reflection angle of 50° in a wavelength range of 450 to 600 nm is 3% or less; and
(a-12) a difference between the average absorptivity at the incidence angle of 0° and the reflection angle of 5° and the average absorptivity at the incidence angle of 50° and the reflection angle of 50° in the wavelength range of 600 to 1200 nm is 5% or less.

7. The optical filter according to claim 6, wherein:
when the absorptivity calculated from the formula (1) is referred to as X, an absorbance is expressed by a following formula (2):
$$Absorbance = - log 10 ( X / 100 ) ; \qquad ( 2 )$$
when the optical filter satisfies the following relational expression, where B1 is an absorbance at a wavelength of 450 nm, B2 is an absorbance at a wavelength of 500 nm, B3 is an absorbance at a wavelength of 550 nm, and B4 is an absorbance at a wavelength of 600 nm at an incidence angle of 0° and a reflection angle of 5°.
$$1 < B 2 / B 1$$
$$0 < B 3 / B 2 < 1$$
$$0 < B 4 / B 3 < 1$$

8. The optical filter according to claim 1, wherein when transmittance (%) at an incidence angle of 5° is referred to as T₍₅₎ and reflectance (%) at an incidence angle of 5° is referred to as R₍₅₎, internal transmittance is expressed by a following formula (3)
$$Internal Transmittance ( \% ) = {T}_{( 5 )} / ( 100 - {R}_{( 5 )} ) \times 100 , \qquad ( 3 )$$
wherein the glass substrate has spectral characteristics specified as:
(b-1) an internal transmittance T_{(g)450} at a wavelength of 450 nm is 92% or more;
(b-2) an average internal transmittance T_{(g)ave1} in a wavelength range of 450 to 600 nm is 90% or more;
(b-3) a minimum wavelength λ_{(g)50} at which the internal transmittance is 50% is in a wavelength range of 625 to 650 nm;
(b-4) an average internal transmittance T_{(g)ave2} in a wavelength range of 750 to 1000 nm is 2.5% or less; and
(b-5) a maximum internal transmittance T_{(g)max} in a wavelength range of 1000 to 1200 nm is 7% or less, and
wherein a Haze value of the glass substrate is 1% or less.

9. The optical filter according to claim 1, wherein when transmittance (%) at an incidence angle of 5° is referred to as T₍₅₎ and reflectance (%) at an incidence angle of 5° is referred to as R₍₅₎, internal transmittance is expressed by a following formula (3):
$$Internal Transmittance ( \% ) = {T}_{( 5 )} / ( 100 - {R}_{( 5 )} ) \times 100 , \qquad ( 3 )$$
wherein the resin layer has spectral characteristics specified as:
(c-1) an internal transmittance T_{(g)450} at a wavelength of 450 nm is 85% or more;
(c-2) an average internal transmittance T_{(g)ave1} in a wavelength range of 450 to 600 nm is 90% or more; and
(c-3) a minimum wavelength λ_{(g)50} at which the internal transmittance is 50% is in a wavelength range from 660 to 700 nm.

10. The optical filter according to claim 9, wherein:
when the internal transmittance calculated from the formula (3) is referred to as Y, absorbance is expressed by a following formula (4):
$$Absorbance = - log 10 ( Y / 100 ) ; \qquad ( 4 )$$
when the optical filter satisfies the following relational expression, where the absorbance at a wavelength of 450 nm is referred to as A1, the absorbance at a wavelength of 500 nm is referred to as A2, the absorbance at a wavelength of 550 nm is referred to as A3, and the absorbance at a wavelength of 600 nm is referred to as A4.
$$0 < A 2 / A 1$$
$$A 3 / A 2 > 1$$
$$A 4 / A 3 > 1$$

11. The optical filter according to claim 1, wherein the first main surface and the second main surface of the glass substrate are coated with an inorganic film.

12. An imaging apparatus having the optical filter of claim 1.
